(19) United States
(12) Patent Application Publication
(10) Pub. No.: US 2008/0042878 A1
(43) Pub. Date: Feb. 21, 2008

(54) PEDESTRIAN ROAD SAFETY SYSTEM

(76) Inventor: Soon Teck HENG, Singapore (SG)

Correspondence Address: HORIZON IP PTE LTD, 8 KALLANG SECTOR, EAST WING, 7TH FLOOR, SINGAPORE 349282, 349282, omitted

(21) Appl. No.: 11/840,200

(22) Filed: Aug. 16, 2007

Related U.S. Application Data
(60) Provisional application No. 60/822,638, filed on Aug. 17, 2006.

(51) Int. Cl. G08G 1/01

(52) U.S. Cl. 340/936; 340/933

(57) ABSTRACT

A road safety system and a method of improving road safety comprising a transmitter, a receiver and a storage medium where the transmitter broadcast signals to the receiver, warning users of the receivers of impending danger. The transmitter also broadcasting information such as real time traffic condition and collision impact data to be recorded in the storage medium when received by the receiver, for the facilitation of ease of responsibility determination upon a collision.

### FIELD OF THE INVENTION

The present invention relates generally to road safety, and more particularly to road safety systems for reduction of occurrences of vehicular collisions and ease of determination of responsibility after the occurrence of a collision.

### BACKGROUND OF THE INVENTION

In vehicular accidents, particularly involving one or more pedestrians crossing a road and a speeding vehicle, collisions between the vehicle and pedestrian are often due to the vehicle traveling at speeds beyond legal speed limits. Pedestrians, also not paying close enough attention to the traffic conditions, may cross a road, unaware of the impending danger. This is especially so under circumstances where visual contact is adversely affected, such as poor weather, at night or poor street lighting.

Often times, the vehicle traveling beyond legal speed limit may be able to not stop in time to avoid collision due to a substantially longer period of time required to decelerate to a full halt. The higher the traveling speed, the longer the time needed to decelerate and vice versa. In an event where collision occurs, much effort is sometimes required to reenact the scene so as to determine responsibility, particularly ‘hit and run’ collisions.

From the foregoing, it is desirable to provide a system that is capable of reducing the probability of vehicular accidents. Additionally, it is also desirable to ensure the system provided is able to aid the determination of responsibility after the occurrence of collision.

### SUMMARY OF THE INVENTION

The present invention relates generally to road safety, and more particularly to road safety systems whereby a road safety system and a method of improving road safety is provided. In one embodiment, the road safety system comprises a transmitter, a receiver and a storage medium in which the receiver having received one or more signals emitted by the transmitter, stores the signals in the storage medium.

In another aspect of the invention, a method of improving road safety is provided. The method comprises of providing a transmitter, a receiver and a recording medium. The recording medium storing signals received by the receiver from the transmitter.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

FIGS. 1-2 show, in operation, a pedestrian road safety system in accordance with embodiments of the invention.

### DETAILED DESCRIPTION OF THE INVENTION

The present invention relates generally to road safety, and more particularly, the present invention relates to a road safety system and method for improving road safety and ease of investigation aftermath of a collision occurrence.

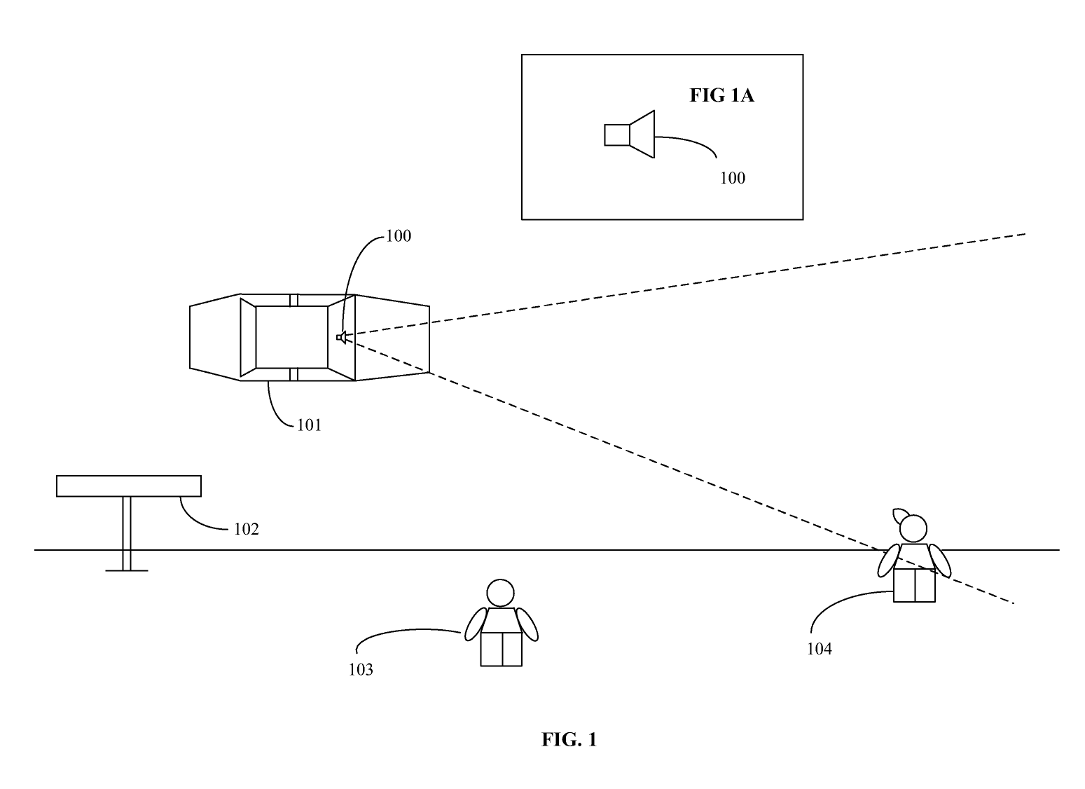

FIG. 1 shows, in operation, a road safety system in accordance to one embodiment of the invention. As shown, a vehicle has been fitted with an in-vehicular unit 100. The in-vehicle unit serves as a transceiver for transmitting and receiving signals. In one embodiment, the signals are received or transmitted wirelessly. For example, wireless signals are transmitted on high carrier frequency range such as radio frequencies (RF). Other frequency ranges are also useful. The RF signal can be in various forms, for example, high-frequency, UWB frequency, RF identification (RFID), or a combination thereof. The RFID can be at frequency ranges of 850 MHz to 950 MHz or 2.4 GHz to 2.5 GHZ. Other frequency ranges are also useful. Alternatively, signals can be transmitted as radar signals in the form of, for example, microwave, at X/K band, or infrared signals.

The in-vehicle unit contains memory which stores information. In one embodiment, the memory stores vehicle information which can be used to identify the vehicle, such as vehicle registration, owner, and owner's address. The memory also stores vehicle speed. Preferably, the vehicle can contain a speed history of the vehicle for a defined period of time. For example, speed of vehicle can be maintained for about a week. Other defined periods are also useful. The speed information can be updated or sampled. For example, the speed information is sampled every 3-5 seconds. Sampling vehicle speed using other sampling periods are also useful. In one embodiment, sampling time can be varied, depending on when the vehicle is moving or not. For example, faster sampling rate can be defined for when the vehicle is moving verses when the vehicle is stopped.

The in-vehicular unit 100, in one embodiment, compares current vehicle speed and a threshold speed limit. In one embodiment, the threshold speed is pre-set locally. In another embodiment, traffic infrastructure, comprising beacon road name signage 102, with embedded RFID tags containing information regarding road name and speed limit etc, transmits the threshold speed limit information to the in vehicular unit 100. Other types of information are also useful. In one embodiment, the memory also stores speed limit information with the vehicle speed information. Other types of information stored with vehicle speed information are also useful. For example, information such as location as well as a time stamp can be associated with the speed information.

In one embodiment, if the speed of the car exceeds the threshold speed, the in-vehicular unit will emit omni-directional signals, acting as warning signals, oriented in the direction in which the car is moving, alerting other road users of the approaching vehicle. The emission of the omni-directional signals will continue until the traveling speed of the vehicle falls below a predetermined range. Preferably, the emission will cease when the traveling speed falls to or below the threshold speed limit. In one embodiment, a microprocessor or microcomputer is used to compare the real-time vehicular traveling speed against the threshold speed limit and compute if warning signals should be broadcasted.

A pedestrian unit, which is carried by a pedestrian, is provided. The pedestrian unit can serve as a receiver which receives the warning signals. For example, the pedestrian unit, when it receives the warning signal, activates an alarm in the unit. In one embodiment, the alarm unit generates audio and/or visual alerts in response to the warning signals. In another embodiment, the alarm unit also captures the vehicular information. Depending on the transmitter strength and/or receiver sensitivity, the alarm unit is capable of capturing vehicular information, automatically or via pedestrian activation, when it is within a certain range from the car. For example, the alarm unit is capable of capturing the vehicular information within an approximate range of 100 feet. In one embodiment, the beacon road name signage pole 102, via a request from the alarm unit, transmits information such as road name and legalized road speed limit to the alarm unit for recording, storage and retrieval. In one embodiment, the recoding or storage medium is a hard disk. Other forms of storage medium are also useful. The information received may be recorded and stored on the hard disk and retrieved as desired.

In one embodiment, an urgent warning signal is generated. The urgent warning signal can be activated via a transmission of a combination comprising more than one signal from in-vehicular device unit. Preferably two signals, for example RF and radar signals, are used to generate the urgent signal. Other combinations are also useful. In one embodiment, the urgent signal is a louder than normal alarm. In another embodiment, the urgent signal is a series of multiple flash lights. Other forms of urgent signal are also useful.

Referring to FIG. 1, where pedestrian 104, standing at a distance further away from speeding vehicle 101 than pedestrian 103, would have received, on his alarm unit, all the above-described information that pedestrian 103 had received. In such an event, pedestrian 104 should be able to receive an urgent warning signal.

FIG. 1A shows a magnified view of in-vehicular device 100. The device can be installed on the car just behind the windscreen, or at the front bonnet. Alternatively, a pair of radar/infrared ray guns can be installed at either side of the front bonnet. Other arrangements are also useful.

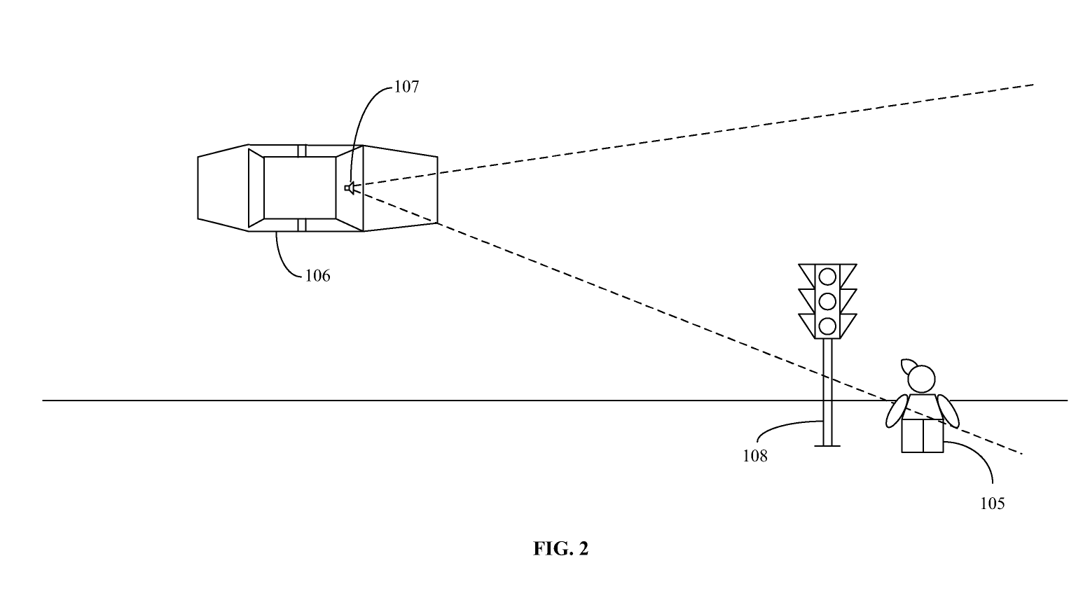

FIG. 2 depicts a vehicle 106 speeding up toward a traffic light junction where a pedestrian 105, carrying an alarm unit (not shown), is waiting to cross. The alarm unit may be a stand-alone hardware device or integrated into commonly utilized hand-held device such as a cell phone. In-vehicular device 107 broadcasts warning signals to the alarm unit if the vehicle exceeds the threshold speed limit. Pertaining to determination of road safety conditions, pedestrian 105, at this instance, can rely on traffic infrastructure, comprising a traffic light 108, and the alarm unit. In one embodiment, traffic light 108 functions as a transmitter, transmitting real time traffic light information in audio and/or visual format to the alarm unit. Traffic light signal changes such as from red (for ‘stop’) to green (for ‘go’) or vice versa and time remaining before the traffic light signal toggles, are examples of information that may be transmitted by traffic light 108. In another embodiment, an impact detector which is capable of detecting an impact, in the event of a collision, is incorporated into the alarm unit. Hence a sequence of the collision can be recorded and made available for scene recreation. Optionally, the vehicular information can be recorded into the alarm unit upon collision for avoidance of doubt in determining the source of impact. The impact detector may comprise exemplarily, a device such as an accelerometer.

For clarity, a working example is set forth:

10.00.15 a.m.—Alarm unit receives signals (RF and radar) of a vehicle approaching at a speed of 90 kph. Vehicular data is captured by the alarm unit.
10.00.30 a.m.—Alarm unit detects that pedestrian is crossing traffic light junction while the traffic is in his favor.
10.01.35 a.m.—Heavy impact is detected by and recorded on the alarm unit. Vehicular data is captured a second time by the alarm unit.

In one embodiment, traffic light 108 functions as a receiver, similar to the alarm unit, and vehicle 106 a transmitter. Traffic light 108 being powered by electricity, facilitates incorporation of a more sensitive receiver. In one embodiment, the traffic light 108 acts as both a transmitter and a receiver, transmitting information concerning, for example, road name and speed limit of the particular road, to the in-vehicular device 107 while receiving information broadcasted from vehicle 106 via in-vehicular device 107.

From the embodiments describing the road safety system, the invention may be extended for other applications, such as identifying harm or crime done against an individual. For example, an aggressor having been obliged to carry a transmitter, such as an RFID tag, broadcasts signals such as the aggressor's particulars. Other signals are also useful. The transmitter, in one embodiment, may include a fail safe feature whereby proper authorities, parties or individuals may be informed when unauthorized tampering of the transmitter occurs. The individual has a receiver capable of receiving and storing the broadcasted particulars so that the particulars can be retrieved for identification when desired. The receiver, in one embodiment, may also be capable of storing the broadcasted particulars together with further details such as a date and/or time stamp. Other details are also useful. In yet another embodiment, surrounding infrastructures such as the traffic infrastructure may also be used to transmit information such as location to the receiver. Other information and other means for transmitting the information may also be useful.

The invention may be embodied in other specific forms without departing form the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A road safety system comprising:
a transmitter;
a receiver for receiving one or more signals transmitted by the transmitter; and
a storage medium,
wherein the storage medium records and stores the signals received by the receiver.

2. The road safety system in claim 1 wherein the transmitter is fitted within a vehicle and/or a traffic infrastructure and the receiver is a handheld device carried by a person.

3. The road safety system in claim 1 wherein both the transmitter and receiver are fitted together as a single device unit.

4. The road safety system in claim 1 wherein the storage medium is a harddisk and the signals stored are capable of being retrieved and reproduced.

5. The road safety system in claim 1 wherein the signal comprises warning signals emitted by the vehicle in the event where the vehicle traveling speed exceeds a threshold speed limit.

6. The road safety system in claim 5 wherein the signal further comprises real-time traffic light condition information and/or collision impact information.

7. The road safety system in claim 5 wherein the warning signal are audio and/or visually perceivable.

8. A method of improving road safety comprising steps of:
providing a transmitter and a receiver, the receiver receiving signals from the transmitter, the signals comprising,
audio and/or visual warning signals when a vehicular traveling speed exceeds a threshold speed limit;
real-time traffic light condition; and
collision impact information;
providing a storage medium, the storage medium capable of recording the signals received by the receiver and reproducing the recorded signals.
